(19) United States
(12) Patent Application Publication
(10) Pub. No.: US 2007/0012823 A1
(43) Pub. Date: Jan. 18, 2007

(54) FLAT-FOLDABLE COMPUTER DESKPAD

(76) Inventor: Don A. Hubbard, Valencia, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/160,836

(22) Filed: Jul. 12, 2005

(51) Int. Cl. B68G 5/00

(52) U.S. Cl. 248/118

(57) ABSTRACT

A flat-foldable computer deskpad includes a portable base having generally planar upper and lower surfaces. A video monitor is connected to the base and pivotable between a viewable position where the monitor extends upwardly from the base, and a storage position where the monitor is received into the base such that a back surface of the monitor lies generally co-planar with the base upper surface. A keyboard is movable relative to the base between a use position where the keyboard extends forward from the base, and a storage position where the keyboard is received into the base.

### BACKGROUND OF THE INVENTION

The present invention is directed generally to deskpads. More particularly, the present invention is directed to a flat-foldable computer deskpad.

In a modern office environment, there are an ever growing number of electronic devices that executives and office workers must have access to, such as a personal computer (desktop or laptop), personal digital assistant (PDA), pager, cellular phone and so on. As the number of these electronic devices grows, more and more of these devices contribute to desk clutter and the office of a business executive begins to look more like an electronics store showroom than an executive office. Even in today's high tech business climate, many executives and professionals, such as lawyers and medical doctors, wish to convey the appearance and prestige of a traditional (albeit low tech) office with office decor in the form of classic leather chairs, wooden desks, book shelves and the like. In the past, the top working surface of an executive's high quality wooden desk would be graced with the presence of a high quality leather deskpad. With the advent of modern electronics, however, the deskpad became lost under the clutter of electronic gizmos like telephones, calculators, computers and the like.

Many different types of deskpads have been employed for use with electronic devices. For example, U.S. Pat. No. 4,748,574 discloses an integrated executive desk unit. However, while the desk unit presents a work area, the work area is cluttered with visible electronic devices and does not provide a way to integrate those devices into the desk unit such that those devices are not visible when not in use. In another example, U.S. Pat. No. 4,766,422 discloses a computer integrated desk. However, this computer is not portable for easy set-up on any desk as the computer is built into the entire desk.

Accordingly, what is needed is a device which provides a computer system adapted to be arranged as part of a deskpad on an office desk. Additionally, a device is needed that incorporates a video monitor of a computer system as part of a deskpad. A device is further needed that is portable and can be used on various desks in various locations. A device is also needed in the form of a computer system integrated into a deskpad such that when the computer system is not in use, the deskpad maintains the appearance of a high quality leather deskpad without a visible video monitor, keyboard or the like. A device is additionally needed such that when a user desires to use the computer, the video monitor and keyboard are readily at the user's fingertips. The present invention fulfills these needs and provides other related advantages.

### SUMMARY OF THE INVENTION

The present invention is directed to a desktop computer housed in what appears at first glance to be nothing more than a traditional deskpad. When the computer is not in use, the deskpad appears to be a conventional high quality leather-type deskpad. However, when a user desires to utilize the computer, the deskpad is easily transformed into a desktop computer with a viewable monitor and keyboard. Additionally, this computer deskpad is portable.

The present invention resides in a flat-foldable computer deskpad including a portable base having generally planar upper and lower surfaces. A video monitor is connected to the base and pivotable between a viewable position where the monitor extends upwardly from the base, and a storage position where the monitor is received into the base such that a back surface of the monitor lies generally co-planar with the base upper surface. A keyboard is movable relative to the base between a use position where the keyboard extends forward from the base, and a storage position where the keyboard is received into the base.

Various components of the computer may be located in the base, monitor, and/or both. These components include, without limitation, a central processing unit, modem, and hard drive.

The upper surface of the base serves a number of functions including, without limitation, a writing surface, mouse pad or the like.

The deskpad includes a side cover movable relative to the base between open and closed configurations, limiting access to devices associated with the computer in the closed configuration and providing access to the devices in the open configuration. The side cover pivots about a plane to place the side cover adjacent to a side of the base in the open configuration and disposed over the base in the closed configuration. The side cover is disposed between planes defined by the upper and lower surfaces of the base in the open configuration. The devices include, without limitation, at least one of the following: a computer mouse, an audio speaker, an on/off switch, and a disc drive.

The keyboard drops down relative to the base in the use configuration.

The back surface of the monitor presents a generally continuous appearance with the base upper surface when the monitor is in the storage configuration.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a deskpad embodying the present invention in a storage configuration;

FIG. 2 is a perspective view of the deskpad of FIG. 1 in the open configuration;

FIG. 3 is a top plan view of the deskpad of FIG. 1 in the storage configuration; and

FIG. 4 is a top plan view of the deskpad of FIG. 2.

### DETAILED DESCRIPTION OF THE PREFERRED EMBODIMENT

The present invention is directed to a super flat desktop computer that is housed in what appears to be a traditional leather-type deskpad.

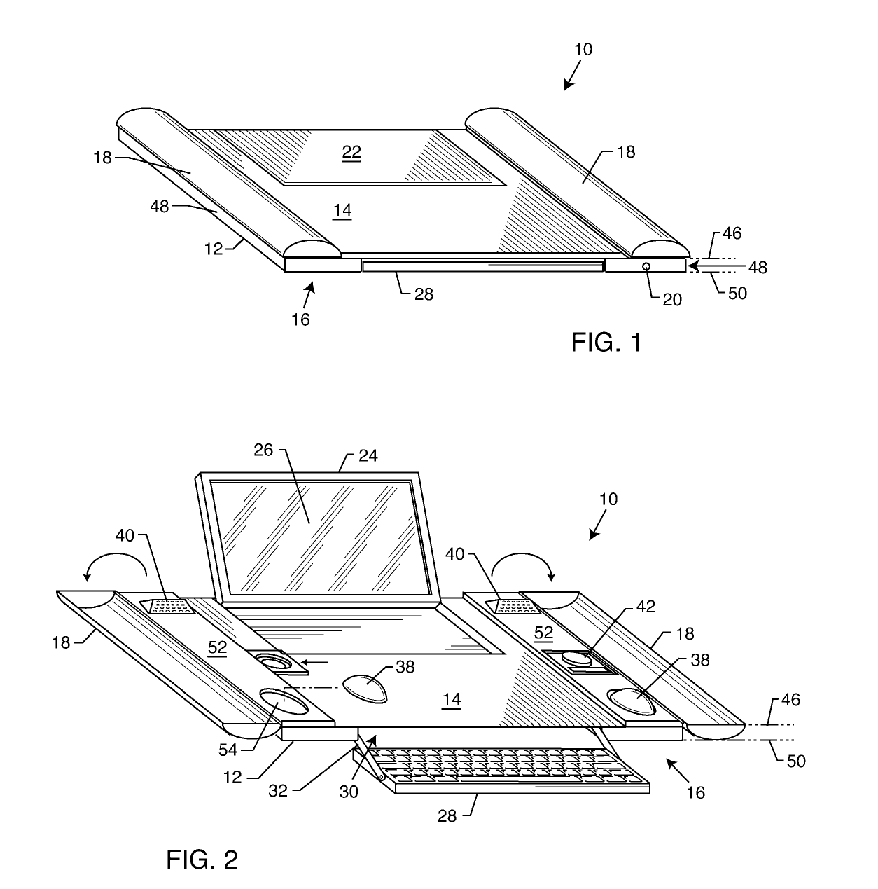

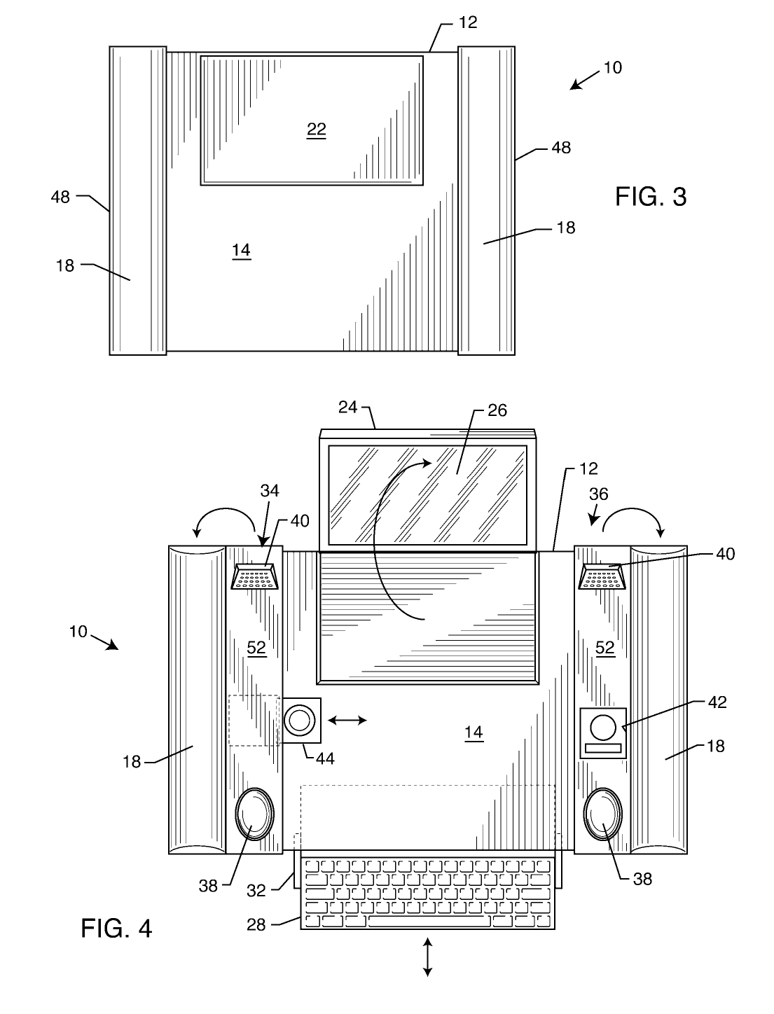

In accordance with one embodiment of the present invention, a portable, flat-foldable computer deskpad 10, as illustrated in FIGS. 1-4, includes a portable base 12 having generally planar upper and lower surfaces 14, 16.

The deskpad 10 is movable between open and storage configurations. In the storage configuration, when the computer is not in use, the deskpad 10 gives the general appearance of a traditional leather-type deskpad with the upper surface 14 serving as a work surface in the form of a writing area bounded on the left and right by side panels 18. An exterior of the side panels 18 is covered with a variety of materials including, without limitation, leather, simulated leather, plastic or the like. However, when a user wishes to utilize the computer functions of the deskpad 10, the user moves the deskpad 10 into the open configuration by flipping up one of the side panels 18 and pushing a button 20 which releases a conventional locking mechanism (not shown) holding a back surface 22 of a video monitor 24 in alignment with the upper surface 14 of the base 12. The release of the locking mechanism causes the video monitor 22 to pivot upwards from the work surface 14 and brings a display surface 26 of the monitor 22 into the view of the user. The surfaces of the work surface 14 and back surface 22 of the monitor 24 are covered with a variety of materials including, without limitation, leather, simulated leather, plastic or the like.

A computer keyboard 28 may be pulled outwards from within the base 12. In the alternative, the release of the locking mechanism may also cause the keyboard 28 to slide outward from a storage configuration within the base 12. The keyboard 28 is movable relative to the base 12 between a use position where the keyboard 28 extends forward from the base 12, and a storage position where the keyboard 28 is received into a recess 30 that opens on a side of the base 12 facing the user. In the storage position, a lower surface of the keyboard 28 lies generally co-planar with the base lower surface 16. The keyboard 28 is connected to the base 12 by a mechanical linkage 32 on each side of the keyboard 28. When the side of the deskpad 10 where the recess 30 is located is generally positioned along a side of a desk, the keyboard 28 can drop down relative to the base 12, between the user and the desk, when the keyboard is moved from the storage position to the use position. The linkage 32 provides sufficient resistance to allow the relative position of the keyboard 28 with respect to the base 12 to be adjusted, allowing the keyboard 28 to then stay in that position.

The monitor 24 is connected to the base 12 and pivotable between a storage position where the monitor 24 is received into the base 12 such that the back surface 22 of the monitor 24 lies generally co-planar with the base upper surface 14 and a viewable position where the monitor 24 extends upwardly from the base 12 and brings the display surface 26 into the view. In this manner, the back surface 22 of the monitor 24 presents a generally continuous appearance with the base upper surface 14 when the monitor 24 is in the storage configuration. The pivotal connection between the monitor 24 and the base 12 includes sufficient resistance to allow the angle of the monitor 24 relative to the base 12 to be adjustable in the viewable configuration. In the alternative, the monitor 24 is connected to the base 12 such that the monitor 24 can be moved towards or away from the user so the monitor 24 is positioned at the most desirable viewing distance from the user.

The deskpad 10 includes various conventional computer components (not shown) that may be located in the base 12, monitor 24, and/or both. These components (not shown) include, without limitation, a central processing unit, modem, and hard drive which are operationally connected to each other and the monitor 24.

The side panels 18 of the deskpad 10 serve as covers over raised portions 34, 36 of the base 12 and are movable relative to the base 12 between open and closed configurations. The side panels 18 limit access to devices associated with the computer in the closed configuration and provide access to those devices in the open configuration. These devices include, without limitation, a wireless computer mouse 38, audio speakers 40, an on/off switch 42, and a disc drive 44. These devices are operationally connected to at least one of the computer components discussed above. In the open configuration, activation of the switch 42 in turn powers the computer within the deskpad 10, allowing the operating system to boot up for use by the user.

The side panels 18 pivot about a plane 46, defined generally by the upper surface 14 of the base 12, to place the side panels 18 adjacent to a side 48 of the base 12 in the open configuration and disposed over the portions 34, 36 of the base 12 in the closed configuration. The panels are disposed between the plane 46 and a plane 50 defined by the lower surface 16 of the base 12, in the open configuration. The panels 18 may be manually pivoted by the user or, in the alternative, automatically open when the user pushes the button 20 to release the locking mechanism that also holds the monitor 24 in the storage configuration if the locking mechanism is operationally engaged to spring-loaded hinges connecting the side panels 18 to the base 12.

Each panel 18 covers a raised section 52 of the portions 34, 36 of the base 12. The mouse 38 for use on the work surface 14 is stored in a recess 54 located on one of these raised sections 52 under either the right or left side panel 18 and is accessed by pivoting open the panel 18 in the manner described above. The computer components and devices discussed above are housed inside the desk pad 10. In addition to the hard drive mentioned above, a CD Rom/DVD drive(s) 44 is positioned under a side panel 18 and slides out from a recess located on a side of one of the raised sections 52. In the alternative, the drive 44 is located on a side of the base 12 of the deskpad 10, preferably the side of the base 12 facing the user. An audio speaker 40 is located on each raised section 52. A microphone (not shown) is built into the deskpad 10.

An external power cord (not shown) and other wire cluster (not shown) exit out of the lower surface 16 of the base 12 of the deskpad 10 through a cord hole (not shown) in the desk. There are multiple locations to plug this cluster into the deskpad 10 on the lower surface 16 of the base 12 for positioning the deskpad 10 on various desks. The deskpad 10 is a complete computer ready to plug in and use. With the exception of the power cord, access to all other outside applications is available through wireless. Alternatively, a number of USB and serial ports (not shown) may be located on the base 12 and/or monitor 24. The deskpad 10 is available in many leather colors and custom patters can be accommodated.

Although an embodiment of the present invention has been described in detail for purposes of illustration, various modifications may be made without departing from the scope and spirit of the invention.

What is claimed is:

1. A flat-foldable computer deskpad, comprising:
a portable base having generally planar upper and lower surfaces;
a video monitor connected to the base and pivotable between a viewable position wherein the monitor extends upwardly from the base, and a storage position wherein the monitor is received into the base such that a back surface of the monitor lies generally co-planar with the base upper surface; and
a keyboard movable relative to the base between a use position wherein the keyboard extends forward from the base, and a storage position wherein the keyboard is received into the base.

2. The computer of claim 1, wherein the base includes at least one of a central processing unit, modem, and hard drive.

3. The computer of claim 1, wherein the monitor includes at least one of a central processing unit, modem, and hard drive.

4. The computer of claim 1, wherein the base upper surface comprises a writing area.

5. The computer of claim 1, wherein the base upper surface comprises a mouse pad.

6. The computer of claim 1, including a side cover movable relative to the base between open and closed configurations, limiting access to devices associated with the computer in the closed configuration and providing access to the devices in the open configuration.

7. The computer of claim 5, wherein the side cover pivots about a plane to place the side cover adjacent to a side of the base in the open configuration and disposed over the base in the closed configuration.

8. The computer of claim 5, wherein the side cover is disposed between planes defined by the upper and lower surfaces of the base in the open configuration.

9. The computer of claim 5, wherein the devices include at least one of the following group comprising a computer mouse, an audio speaker, an on/off switch, and a disc drive.

10. The computer of claim 1, wherein the keyboard drops down relative to the base in the use configuration.

11. The computer of claim 1, wherein the back surface of the monitor presents a generally continuous appearance with the base upper surface when the monitor is in the storage configuration.

12. A flat-foldable computer deskpad, comprising:
a portable base having generally planar lower surface and a generally planar upper surface having a writing area;
a video monitor connected to the base and pivotable between a viewable position wherein the monitor extends upwardly from the base, and a storage position wherein the monitor is received into the base such that a back surface of the monitor lies generally co-planar with the base upper surface and presents a generally continuous appearance with the base upper surface; and
a keyboard movable relative to the base between a use position wherein the keyboard extends forward from the base, and a storage position wherein the keyboard is received into the base.

13. The computer of claim 12, wherein the base includes at least one of a central processing unit, modem, and hard drive.

14. The computer of claim 12, wherein the monitor includes at least one of a central processing unit, modem, and hard drive.

15. The computer of claim 12, wherein the base upper surface comprises a mouse pad.

16. The computer of claim 12, including a side cover movable relative to the base between open and closed configurations, limiting access to devices associated with the computer in the closed configuration and providing access to the devices in the open configuration, the devices including at least one of the following group comprising a computer mouse, an audio speaker, an on/off switch, and a disc drive.

17. The computer of claim 16, wherein the side cover pivots about a plane to place the side cover adjacent to a side of the base in the open configuration and disposed over the base in the closed configuration.

18. The computer of claim 16, wherein the side cover is disposed between planes defined by the upper and lower surfaces of the base in the open configuration.

19. The computer of claim 1, wherein the keyboard drops down relative to the base in the use configuration.

20. A flat-foldable computer deskpad, comprising:
a portable base having generally planar lower surface and a generally planar upper surface having a writing area that comprises a mouse pad;
a video monitor connected to the base and pivotable between a viewable position wherein the monitor extends upwardly from the base, and a storage position wherein the monitor is received into the base such that a back surface of the monitor lies generally co-planar with the base upper surface and presents a generally continuous appearance with the base upper surface;
a side cover movable relative to the base between open and closed configurations, limiting access to devices associated with the computer in the closed configuration and providing access to the devices in the open configuration, the devices including at least one of the following group comprising a computer mouse, an audio speaker, an on/off switch, and a disc drive, and wherein the side cover pivots about a plane to place the side cover adjacent to a side of the base in the open configuration and disposed over the base in the closed configuration; and
a keyboard movable relative to the base between a use position wherein the keyboard extends forward from the base, and a storage position wherein the keyboard is received into the base.
